(19) United States
(12) Patent Application Publication
(10) Pub. No.: US 2017/0130763 A1
(43) Pub. Date: May 11, 2017

(54) GRIP FOR SMOOTH SURFACES

(71) Applicant: Center-Plus Slawomir Lech, Warszawa (PL)

(72) Inventor: Slawomir Lech, Warszawa (PL)

(21) Appl. No.: 14/295,991

(22) Filed: Jun. 4, 2014

(30) Foreign Application Priority Data
Jun. 5, 2013 (PL) 20130211913

(51) Int. Cl. F16B 47/00; F16M 13/02

(52) U.S. Cl. CPC F16B 47/00; F16M 13/022; A47K 3/001

(57) ABSTRACT

The grip fixes objects made of wire or plastic to smooth surfaces. It is made of a suction cup with a screw embedded in it, a hard dome shaped or cylindrical overlay with a hollow surface on the side of the suction cup with a hole in the middle and a cylindrical nut and a round finishing and a cutting off in the lower part, specific with the fact that the overlay has a centrally situated depression on its outside surface and two channels, and on its edge on the side of the suction cup it has insets, which stick in the peripheral part of the same suction cup in effect of its round shape and a bigger diameter than the overlay.

### CROSS-REFERENCE FOR RELATED APPLICATIONS

This utility patent application filed under 35 USC §111 claims priority to Polish patent application W.122119 filed on Jun. 5, 2103, which is incorporated by reference herein.

### TECHNICAL FIELD

The subject is a grip, which serves to fix things made of wire or plastic to a smooth surface such as glass, glazed tiles.

### BACKGROUND

Grips using suction cups are known, such as for example, made of a suction cup with a screw embedded in it, a hard overlay in the shape of a dome with a hole and nuts on top. The suction cup contacts the smooth surface, for example glass, a hard, overlay dome is placed on it so that the screw goes through the hole in the overlay. Next the drilled hole in the wire is put on the overlay and tightened with a nut. Tightening the nut makes the screw move outside the overlay and lifts the middle of the suction cup. The lifting force causes a vacuum, which clamps the overlay and so it presses the grip to the smooth surface and, by the same, the fixed object made of a wire.

This can cause instability of the fixed object if only one suction cup is used. The clamped object may rotate towards the overlay, where the suction cup screw is the pivot. It may also deviate from the level in result of a load. Considering all that, in order to achieve the stability of the fixed object it is necessary to have at least two grips.

### SUMMARY

The grip, serving to fix things made of wire, for example wire bathroom baskets to smooth surfaces, is made of a suction cup with a screw embedded in it, a hard overlay with a hollow surface on the side of the suction cup with a hole in the middle and a nut, is specific in this way that the overlay, on its outside surface, has a centrally situated depression and two channels. It is also possible to make variants with a single channel, or three or even four channels. The overlay has a dome shape and on its edge at the base, on the side of the suction cup, it has insets (projections). In another variant the overlay has a cylinder shape. The suction cup is round and the overlay has a smaller diameter than the suction cup. The nut is cylindrical with a round finishing and a smash (cutting off) in the lower part.

The advantage is the elimination of the rotation of the pressed object towards the grip and a firmer stabilization of the clamped object made of a wire or plastic by its better stabilization in the vertical and horizontal position and, by the pressing of the nut on the outside surface of the suction cup evoked by the vacuum and assembling the very wire in the depressions on the surface of the overlay.

When applying the grip in order to achieve a full stability of the fixed object it is necessary to have a smaller number of grips, which makes it much easier and faster to fix the object.

### BRIEF DESCRIPTION OF THE DRAWINGS

FIG. 1 shows a perspective view of the grip placed on the suction cup, a dome overlay and a nut;

FIG. 2 is a perspective rear view of the same overlay;

FIG. 3 is an overlay with a channel;

FIG. 4 shows the overlay with rod fitted in the channel;

FIG. 5 shows the grip fixed to a wire basket;

FIG. 6 shows the grip fixed to the wire basket seen from the front; and

FIG. 7 presents the same fixed wire basket seen from the lateral perspective.

### DETAILED DESCRIPTION OF PREFERRED EMBODIMENTS

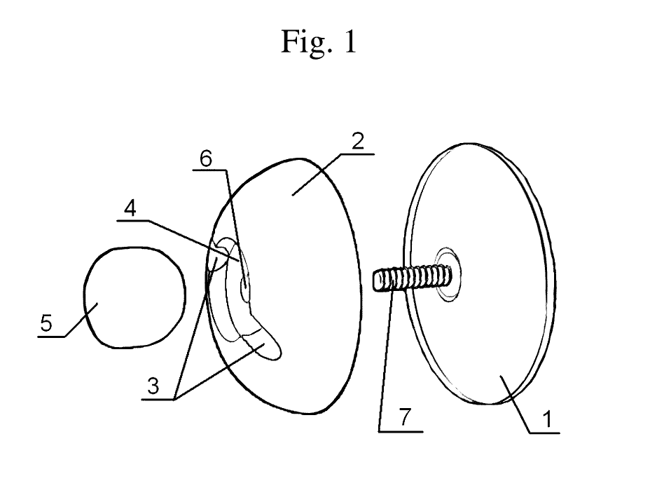

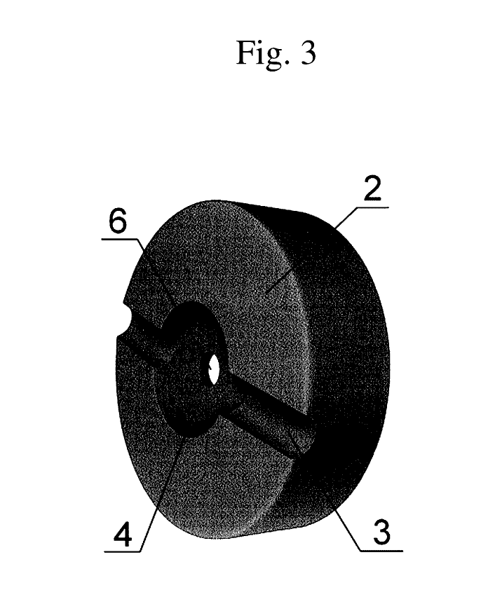

Referring to FIG. 1, the grip serves for fixing a wire object, for example, a wire bathroom basket to smooth surfaces made of a suction cup 1 with a screw embedded in it 7, a hard overlay 2 with a hole 6 in the middle and a nut 5. Referring to FIG. 3, the overlay 2 has a depression 4 on top and two channels 3 on its surface.

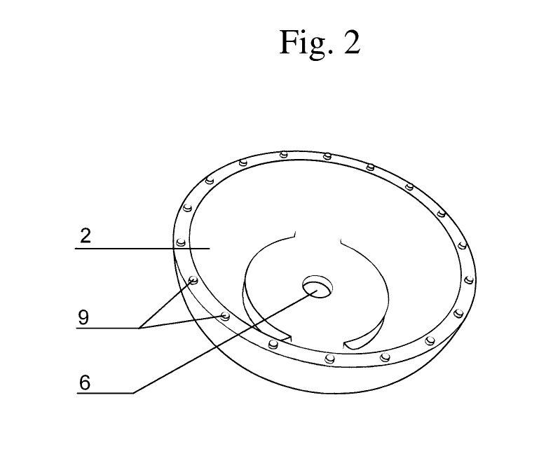

Referring to FIG. 2, overlay 2 on its edge on the part of the suction cup has projections 9.

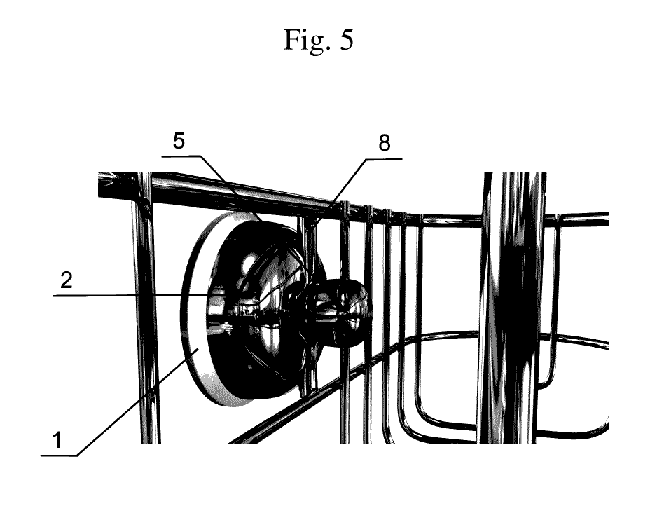

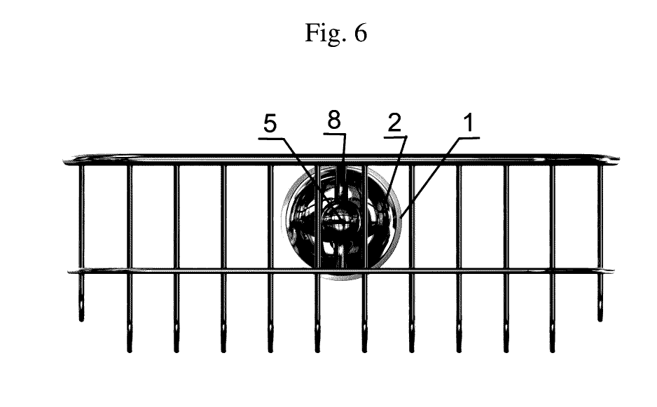

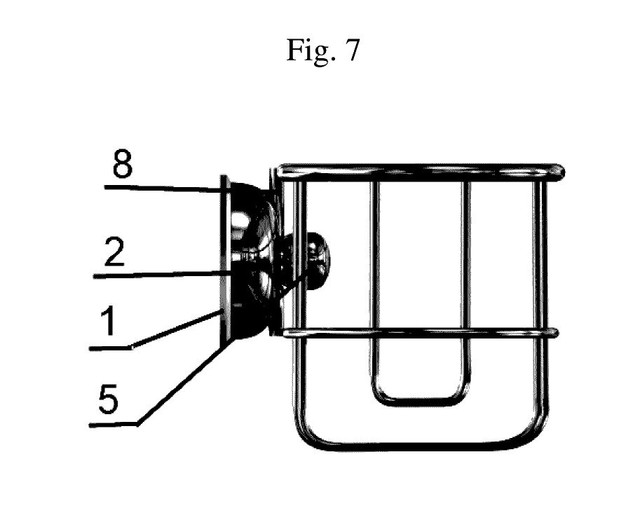

Referring to FIGS. 5-7, the wire rod of the basket 8 fits in the channels 3 and the depression 4 on the outside surface of the overlay 2. Screw 7 embedded in the suction cup 1 goes through hole 6 in overlay 2 and through the hole in rod 8 of the fixed part. Clamping the nut 5 makes the screw 7 move outside the overlay 2, which causes a vacuum under the suction cup 1. The rod of the fixed part 8 is pressed into the overlay 2 and the overlay 2 is pressed into the peripheral part of suction cup 1.

The projections 9 (see FIG. 2) of the overlay 2 edge on the side of the suction cup stick into the peripheral part of the suction cup and stabilize the overlay and prevent its rotation towards the suction cup.

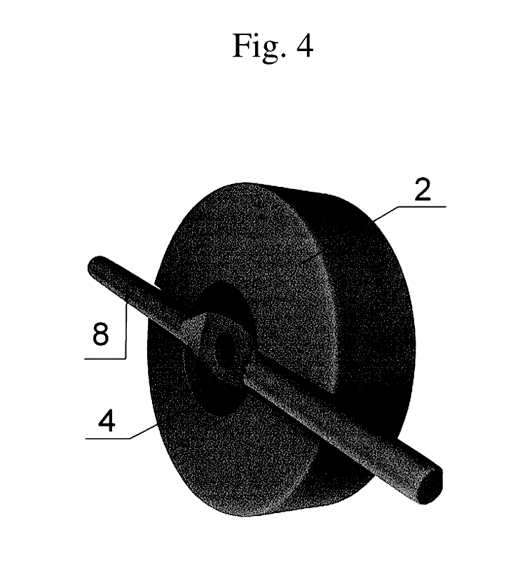

Referring to FIG. 4, rod 8 of the fixed part is fitted in the channels 3 and depression 4 on the outside surface of overlay 2, pressed into the overlay 2 and the suction cup 1 is stabilized in all possible directions, namely vertically and horizontally and its rotation is impossible.

1. A grip, made of a suction cup with a screw embedded in it, a hard overlay with a hollow surface on the side of the suction cup with a hole in the middle and a nut, specific with the fact that the overlay (2) has a centrally located depression (4) in its outside surface and two channels (3).

2. Grip based on claim 1, specific with the fact that the overlay (2) has a dome shape.

3. Grip based on claim 1, specific with the fact that the overlay (2) has a cylindrical shape.

4. Grip based on claim 1, specific with the fact that the overlay (2) diameter is smaller than the diameter of the suction cup (1).

5. Grip based on claim 1, specific with the fact that the overlay (2) on its edge on the side of the suction cup has three projections (9).

6. Grip based on claim 1, specific with the fact that the suction cup (1) has a round shape.

7. Grip based on claim 1, specific with the fact that the nut (5) has a cylindrical shape with round finishing and cutting off in the lower part.
